(19) United States
(12) Patent Application Publication
(10) Pub. No.: US 2026/0335855 A1
(43) Pub. Date: Oct. 29, 2026

(54) DECARBONIZATION BY SOLAR-ASSISTED TUNABLE CARBONHYDROGEN-OXYGEN INTEGRATION TO SOLID CARBON AND ENRICHED SYNGAS

(71) Applicants: HAMAD BIN KHALIFA UNIVERSITY, Doha (QA); Texas A&M University, College Station, TX (US); QATAR FOUNDATION FOR EDUCATION, SCIENCE AND COMMUNITY DEVELOPMENT, Doha (QA)

(72) Inventors: Mahmoud M. El-Halwagi, Doha (QA); Nimir O. Elbashir, Doha (QA); Debalina Sengupta, Doha (QA); MohamedSufiyan A. Challiwala, Doha (QA); Hanif A. Choudhury, Doha (QA)

(21) Appl. No.: 19/099,693

(22) PCT Filed: Aug. 2, 2023
(86) PCT No.: PCT/QA2023/050012

§ 371 Date: Jan. 29, 2025

Related U.S. Application Data
(60) Provisional application No. 63/394,824, filed on Aug. 3, 2022.

(51) Int. Cl. B01J 19/00; C01B 3/36; C01B 32/154; C01B 32/16; C01B 32/20; C01B 32/40

(52) U.S. Cl. CPC B01J 19/0033; C01B 3/36; C01B 32/154; C01B 32/16; C01B 32/20; C01B 32/40; B01J 2219/00191

(57) ABSTRACT

A system includes an allocation control system configured to receive oxygen gas, methane gas, carbon dioxide gas, and steam, determine a proper ratio of the oxygen gas, the methane gas, the carbon dioxide gas, and the steam, and mix the oxygen gas, the methane gas, the carbon dioxide gas, and the steam according to the determined ratio to generate a mixture stream. The system further includes a syngas and carbon generator configured to: receive the mixture stream from the allocation control system, and generate syngas and solid carbon using the received mixture stream, wherein the syngas comprises hydrogen gas and carbon monoxide gas. The proper ratio of the oxygen gas, the methane gas, the carbon dioxide gas, and the steam is determined using an atomic tracking model based on a predetermined condition for the syngas and the solid carbon to be generated by the syngas and carbon generator.

### CROSS-REFERENCE TO RELATED APPLICATION

The present application claims priority to U.S. Provisional Application No. 63/394,824 filed Aug. 3, 2022 and entitled “DECARBONIZATION BY SOLAR-ASSISTED TUNABLE CARBON-HYDROGEN-OXYGEN INTEGRATION TO SOLID CARBON AND ENRICHED SYNGAS,” the disclosure of which is incorporated by reference herein in its entirety.

### BACKGROUND

There is global consensus on the need to reduce CO₂ emissions. Formal agreements (e.g., Glasgow Climate, Paris Agreement, Kyoto protocol) and voluntary initiatives have called for substantial reduction in the carbon footprint. In this context, there has been an effort to create CO₂ pipelines associated with carbon capture, utilization, and storage (CCUS). The CO₂ pipelines may collect CO₂ emissions (primarily from power plants and industrial sources) and deliver them for use mostly in enhanced oil recovery (EOR) and storage in geological formations.

### SUMMARY

The present disclosure generally relates to an integrated system and method for decarbonization that uses solar energy, CO₂, CH₄, and/or H₂O to produce value-added solid carbon and enriched syngas.

In light of the present disclosure, and without limiting the scope of the disclosure in any way, in an aspect of the present disclosure, which may be combined with any other aspect listed herein unless specified otherwise, a system for decarbonization is provided. The system may include an allocation control system configured to receive oxygen gas, methane gas, carbon dioxide gas, and steam, determine a proper ratio of the oxygen gas, the methane gas, the carbon dioxide gas, and the steam, and mix the oxygen gas, the methane gas, the carbon dioxide gas, and the steam according to the determined ratio to generate a mixture stream. At least a portion of the carbon dioxide gas may be supplied from a carbon dioxide gas pipeline delivering carbon dioxide containing wastes generated from one or more industrial facilities. The system may further include a syngas and carbon generator configured to receive the mixture stream from the allocation control system, and generate syngas and solid carbon using the received mixture stream. The syngas may include hydrogen gas and carbon monoxide gas. The proper ratio of the oxygen gas, the methane gas, the carbon dioxide gas, and the steam may be determined using an atomic tracking model based on a predetermined condition for the syngas and the solid carbon to be generated by the syngas and carbon generator.

In light of the present disclosure, and without limiting the scope of the disclosure in any way, in an aspect of the present disclosure, which may be combined with any other aspect listed herein unless specified otherwise, a method for decarbonization is provided. The method may include receiving oxygen gas, methane gas, carbon dioxide gas, and steam, determining a proper ratio of the oxygen gas, the methane gas, the carbon dioxide gas, and the steam; mixing the oxygen gas, the methane gas, the carbon dioxide gas, and the steam according to the determined ratio to generate a mixture stream; and generating syngas and solid carbon using the generated mixture stream. At least a portion of the carbon dioxide gas may be supplied from a carbon dioxide gas pipeline delivering carbon dioxide containing wastes generated from one or more industrial facilities. The syngas may include hydrogen gas and carbon monoxide gas. The proper ratio of the oxygen gas, the methane gas, the carbon dioxide gas, and the steam may be determined using an atomic tracking model based on a predetermined condition for the syngas and the solid carbon to be generated.

Additional features and advantages of the disclosed systems and methods are described in, and will be apparent from, the following Detailed Description and the Figures.

### BRIEF DESCRIPTION OF THE FIGURES

FIG. 1 is a diagram of an example system for decarbonization according to an example of the present disclosure.

FIG. 2 is a graph showing the effect of CO₂:CH₄ molar ratio in the feed on H₂:CO ratio (r), CO (d), and Solid Carbon Formation (e) for a CH₄ and CO₂ feed.

FIG. 3 is a flow chart illustrating an example process of operating the system of FIG. 1 according to an example of the present disclosure.

FIG. 4 is a diagram illustrating an industrial facility combined with the system 100 of FIG. 1 according to an example of the present disclosure.

### DETAILED DESCRIPTION OF EXAMPLE EMBODIMENTS

The present disclosure generally relates to an integrated system and method for decarbonization that may use solar energy, carbon dioxide (CO₂), methane (CH₄), and/or steam (H₂O) to produce value-added solid carbon and enriched syngas.

There is global consensus on the need to reduce CO₂ emissions. Formal agreements (e.g., Glasgow Climate, Paris Agreement, Kyoto protocol) and voluntary initiatives have called for substantial reduction in the carbon footprint. In this context, a promising endeavor may be the creation of CO₂ pipelines associated with carbon capture, utilization, and storage (CCUS). The CO₂ pipelines may collect CO₂ emissions (e.g., from power plants and industrial sources) and deliver them for use in enhanced oil recovery (EOR) and storage in geological formations.

In addition to the 4,500 miles of existing CO₂-pipeline systems in the United States, it is anticipated that 7,500 miles of new CO₂ pipelines will be constructed in the United States with an estimated cost of $20 billion. Qatar also has recently commissioned the largest CO₂ capture plant in the Middle East with a project capacity of five million tons per year, mostly from the liquefied natural gas (LNG) facilities and plans to create associated pipeline and utilization infrastructure.

Natural gas pipelines are among the most ubiquitous infrastructures in the energy sector. For instance, the United States has a three-million-mile natural gas pipeline that delivers about 30 trillion cubic feet of gas to approximately 80 million customers. The composition of natural gas transported in pipeline varies. For instance, one reported composition contains 95.4% methane and 2.0% CO₂.

A typical CO₂ pipeline collects CO₂-containing wastes from the power plants and industrial facilities. In some cases, the waste streams are treated (to enhance the CO₂ concentration or remove objectionable species) prior to feeding to the CO₂ pipeline. In other cases, the waste streams may be fed to the pipeline in their raw composition. Typically, the CO₂ composition in the pipeline may range from 75.00 to 99.95 mol %.

Coke formation during a Dry Reforming of Methane (DRM) process has traditionally been considered a substantial problem and the key hurdle towards commercialization. Nonetheless, high-value solid carbon and syngas can be deliberately produced from CO₂ and methane by tailored system design and operating conditions as well as proper catalyst selection. Not only does the production of value-added solid carbon enhance the economic viability of the process but it also contributes to a major reduction in the carbon footprint because of several reasons including (1) carbon stabilization in the form of a solid (compared to the conversion of CO₂ to a fuel which is subsequently burned to release CO₂), (2) control of the type of carbon material produced in the form of multi-wall carbon nanotubes (MWCNTs) and (3) using the produced carbon to substitute other carbon products (e.g., carbon black, activated carbon, carbon nanotubes) that would have been produced from fossil sources and other hydrocarbons with a potentially higher carbon footprint.

The development of CO₂-monetization technologies can substantially reduce the carbon footprint to value-added solid carbon. The CARbon GENerator (CARGEN) technology has evolved the DRM process into a two-stage reaction system that produces high-quality solid carbon (e.g., MWCNT) and tunable syngas, hydrogen, or value-added chemicals. The production of solid carbon serves as promising carbon capture and sequestration technique and the value of products such as MWCNT and syngas offer significant economic benefits. Tunable CO₂-monetization may enable at least a 50% reduction in energy requirement with at least 65% CO₂ conversion compared to the DRM process.

Some example systems and methods for producing syngas or solid carbon are disclosed by International Patent Application No. PCT/US2018/025696 titled SYSTEM AND METHOD FOR CARBON AND SYNGAS PRODUCTION, which was filed on Apr. 2, 2018; International Patent Application No. PCT/US2019/014922 titled AN INTEGRATED AND TUNABLE SYSTEM FOR THE PRODUCTION OF SYNGAS AND CHEMICALS VIA SOLAR-ASSISTED ELECTROLYSIS AND COMBINED REFORMING, which was filed on Jan. 24, 2019; and International Patent Application No. PCT/QA2019/050005 titled REGENERATION AND ACTIVATION OF CATALYSTS FOR CARBON AND SYNGAS PRODUCTION, which was filed on Mar. 13, 2019, the disclosure of each of which is hereby incorporated by reference in its entirety.

Aspects of the present disclosure may provide a distributed network of DECARBonization via Solar-assisted Tunable Carbon-Hydrogen-Oxygen Integration to Solid Carbon and Enriched Syngas (“DECARBS-TCHOISCES”) that may allow the processing/industrial facilities to not just export the wastes to the CO₂ pipelines but to also import CO₂-containing wastes and monetize them to syngas (that can be used in the processing facilities) and solid carbon with unique qualities (including lowering the LCA-based carbon footprint of the system).

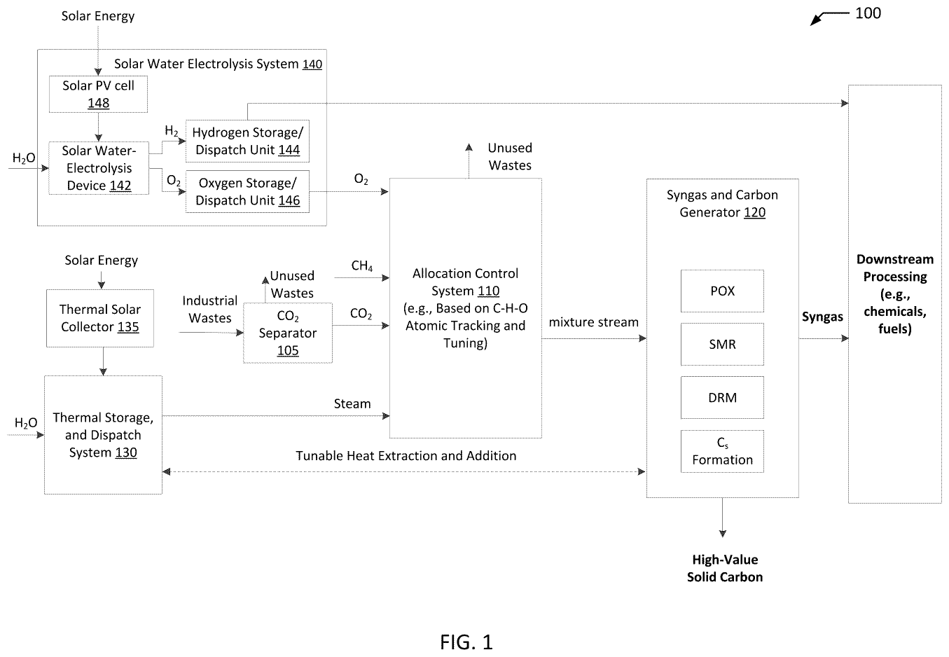

FIG. 1 illustrates a diagram of an example system 100 for decarbonization according to an example of the present disclosure. As shown in FIG. 1, the system 100 may include an allocation control system 110 and a syngas and carbon generator 120. In some examples, the allocation control system 110 may receive oxygen gas (O₂), methane gas (CH₄), carbon dioxide gas (CO₂), and steam (H₂O), and determine a proper ratio of the oxygen gas, the methane gas, the carbon dioxide gas, and the steam.

In some examples, at least a portion of the carbon dioxide gas may be supplied from a carbon dioxide gas pipeline delivering carbon dioxide containing wastes generated from one or more industrial facilities. In some examples, the system 100 may further include a CO₂ separator 105. In this case, CO₂-containing industrial wastes may be collected and fed to the CO₂ separator 105 (e.g., absorption/desorption) to separate carbon dioxide gas from other gas in the CO₂-containing industrial wastes. In other examples, the carbon dioxide may be supplied from any other suitable source. In some examples, the methane may be supplied from a natural gas pipeline. In other examples, the methane may be supplied from any other suitable source.

In some examples, the allocation control system 110 may further mix the oxygen gas, the methane gas, the carbon dioxide gas, and the steam according to the determined ratio to generate a mixture stream. In some examples, the oxygen gas, the methane gas, the carbon dioxide gas, and the steam may be mixed according to the determined ratio by adjusting a flow rate of at least one or all of the oxygen gas, the methane gas, the carbon dioxide gas, and the steam.

The syngas and carbon generator 120 may receive the mixture stream from the allocation control system 110, and generate syngas and solid carbon using the received mixture stream. The syngas may include hydrogen gas (H₂) and carbon monoxide gas (CO). In some examples, the syngas may further include H₂O, O₂, CO₂, CH₄, and/or C₁-C₅ (traces). In some examples, the H₂ to CO ratio in the syngas may be in the range of 0.01-99 (molar).

In some examples, the proper ratio of the oxygen gas, the methane gas, the carbon dioxide gas, and the steam may be determined using an atomic tracking model based on a predetermined condition for the syngas and the solid carbon to be generated by the syngas and carbon generator 120.

In some examples, the predetermined condition for the solid carbon and syngas may refer to particular target carbon material quality and syngas quality. For example, the predetermined condition for the solid carbon may be a specific composition of the solid carbon and/or different allotropes of carbon. The specific composition of the solid carbon that can be produced from the system 100 may include at least one of carbon black, graphitic carbon, carbon nanotube (e.g., MWCNTs), graphene, and amorphous carbon. In some examples, the predetermined condition for the syngas may be a ratio between the hydrogen gas (H₂) to the carbon monoxide gas (CO).

In some examples, the atomic tracking model may use the following chemical equation:

CH₄+aCO₂+bH₂O+cO₂→dCO+r*dH₂+eCs Equation (1)

In Equation (1), a, b, c, d, and e are coefficients, and r is a ratio between the hydrogen gas (H₂) to the carbon monoxide gas (CO).

For a given feed stream mixture, the coefficients a, b, and c may be known. The coefficients d, r*d, and e can be determined through atomic balances. For example, the Carbon, Hydrogen, and Oxygen balances can be expressed as follows:

(Carbon Balance) 1+a=d+e Equation (2)

(Hydrogen balance) 4+2b=2r*d Equation (3)

(Oxygen balance) 2a+b+2c=d Equation (4)

For a given feed stream mixture with known a, b, and c, the three atomic balances can be solved simultaneously to determine the values of d, r, and e as follows:

d=2a+b+2c Equation (5)

r=(2+b)/d Equation (6)

e=1+a−d Equation (7)

In some examples, the proper ratio of the oxygen gas, the methane gas, the carbon dioxide gas, and the steam may be determined by determining the coefficients of a, b, and c based on a predetermined value of d, e, and/or r. For example, for desired specifications/conditions of d, e, and r, Equations 5-7 can be solved to determine the unique values of a, b, and c for tuning the feedstock.

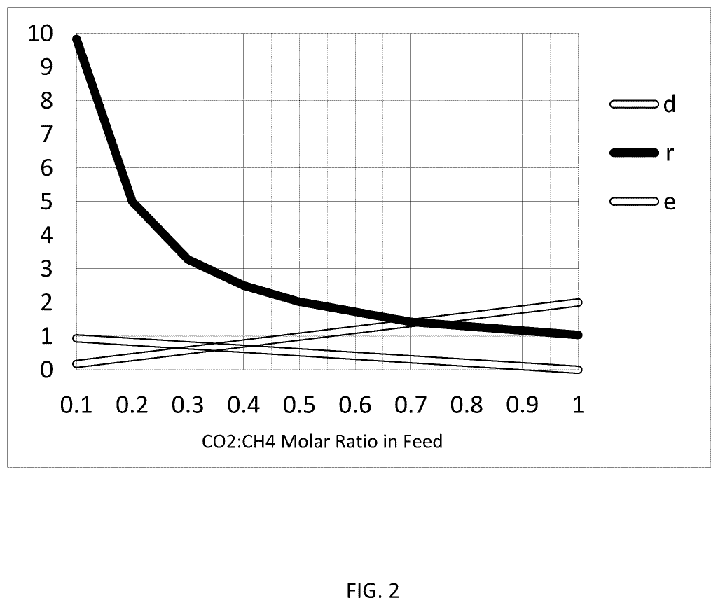

For example, if it is assumed that the feed is composed of a mixture of CH₄ and CO₂ only (i.e., b=0, and c=0), the impact of the molar ratio of CO₂ to CH₄ in the feed (a) on the values of d, e, and r can be shown in FIG. 2.

Similarly, FIG. 2 can be used to tune the products by adjusting the proportions of the sources contributing to the feed. For instance, if a value of r=2 is needed for the H₂:CO ratio, then the proportions of the feed sources may be adjusted to provide a 0.5 molar ratio of CO₂ to CH₄. In this case, 0.5 moles of solid carbon may be formed as a product per mole of CH₄ in the feed.

As discussed above, in the present disclosure, reaction data/kinetic data may be used to target a particular quality of solid carbon material. For example, a specific composition may be needed to produce carbon black, and other specific compositions may be needed to produce graphite, carbon nanotubes, and graphene. Therefore, the above-discussed bottom-up approach algorithm with feedback may be used that is dependent on the quality of the carbon material while governing the quantity and quality of CO₂ streams imported from the network. Similarly, this bottom-up approach may be used to identify the feed composition to target a particular syngas quality.

In some examples, the syngas and carbon generator 120 may generate the syngas using at least one of a Steam Methane Reforming (SMR) technique, a Partial Oxidation (POx) technique (or combinations such as auto-thermal reforming (ATR)) and a Dry Reforming of Methane (DRM) technique. For example, natural gas (primarily methane) may be reformed to produce synthesis gas (syngas) composed mainly of H₂ and CO. The SMR, POx, and DRM process can be expressed as follows:

$$\begin{matrix}SMR & {CH}_{4} + {H}_{2} O \to 3 {H}_{2} + CO & Δ {H}_{298} = 206 kJ / mol\end{matrix} \qquad Equation ( 8 )$$

$$\begin{matrix}POx & {CH}_{4} + \frac{1}{2} {O}_{2} \to 2 {H}_{2} + CO & Δ {H}_{298} = - 36 kJ / mol\end{matrix} \qquad Equation ( 9 )$$

$$\begin{matrix}DRM & {CH}_{4} + {CO}_{2} \to 2 {H}_{2} + 2 CO & Δ {H}_{298} = 247 kJ / mol\end{matrix} \qquad Equation ( 10 )$$

One of the key characteristics of syngas may be the H₂:CO ratio (for SMR~3.5 and above, for ATR~2.5, for POx~1.9, and for DRM~1). The POx process may be exothermic, and SMR and DRM processes may be endothermic. In some examples, the syngas and carbon generator 120 may generate the solid carbon using a carbon generator (CARGEN) reactor.

In some examples, the system 100 may further include a thermal storage and dispatch system 130. In some examples, the thermal storage and dispatch system 130 may be supplied with water and produce steam using the water. The steam produced by the thermal storage and dispatch system 130 may be supplied to the allocation control system 110 as shown in FIG. 1. In some examples, the thermal storage and dispatch system 130 may extract heat from the syngas and carbon generator 120 when the syngas and carbon generator 120 is in an exothermic state, and supply heat to the syngas and carbon generator 120 when the syngas and carbon generator 120 is in an endothermic state. This may minimize external heating and cooling.

In some examples, the system 100 may further include a thermal solar collector 135 that is used with the thermal storage and dispatch system 130. For example, the thermal solar collector 135 may collect heat by absorbing solar energy (e.g., sunlight) and supply the collected heat to the thermal storage and dispatch system 130. The thermal storage and dispatch system 130 can supply the heat from the thermal solar collector 135 to the syngas and carbon generator 120 when the syngas and carbon generator 120 is in an endothermic state.

In some examples, the system 100 may include a solar water electrolysis system 140. The solar water electrolysis system 140 may include a solar water-electrolysis device 142. The solar water-electrolysis device 142 may be supplied with water and produce hydrogen gas and oxygen gas via electrolysis of the water using solar energy. In some examples, the solar water electrolysis system 140 may further include a hydrogen storage/dispatch unit 144 and an oxygen storage/dispatch unit 146. The hydrogen gas produced by the solar water-electrolysis device 142 may be stored in the hydrogen storage/dispatch unit 144, and the oxygen gas produced by the solar water-electrolysis device 142 may be stored in the oxygen storage/dispatch unit 146. The oxygen stored in the oxygen storage/dispatch unit 146 may be supplied to the allocation control system 110. In some examples, the oxygen utilized for co-production of syngas and solid carbon may be completely or partially obtained from the solar water electrolysis system 140.

In some examples, the solar water electrolysis system 140 may further include a solar photovoltaic (PV) cell 148. The solar PV cell 148 may supply electricity to the solar water electrolysis system 140.

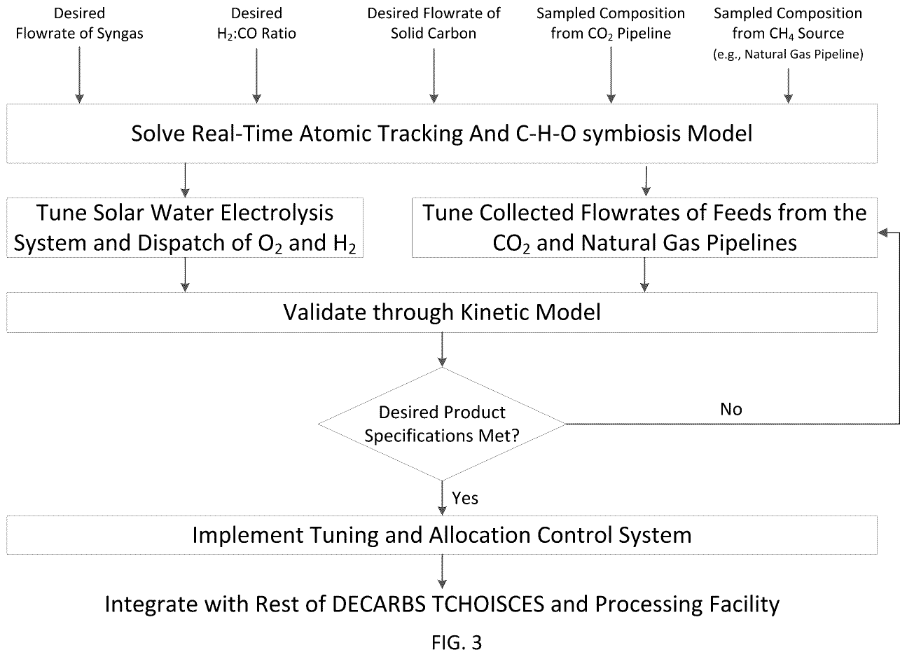

The aforementioned DECARBS-TCHOISCES algorithm/equations can be used to design the control system managing the integration of the streams from the CO₂ pipeline, natural gas pipeline, solar energy, and processing facilities. FIG. 3 is a high-level representation of the flowchart governing/managing the real-time tuning and control system. For example, a desired flowrate of syngas, desired H₂:CO ratio, desired quality of solid carbon, sampled composition from CO₂ pipeline, and/or sampled composition from CH₄ source may be provided as an input, and a proper ratio of the oxygen gas, the methane gas, the carbon dioxide gas, and the steam may be determined using an atomic tracking (and C—H—O symbiosis) model based on the provided input. Based on the determined proper ratio, the solar water electrolysis system may be tuned, and the flowrates of the carbon dioxide gas and the methane gas may be tuned. Also, in some examples, this might be validated through a kinetic model. In some examples, various combinations of reaction pathways, conditions, and catalysts can be optimized to provide the kinetics needed to achieve the targets. If the product specifications for the syngas and solid carbon are met, the system may implement the tuning and operate the allocation control system and the syngas and carbon generator accordingly. If not, the step may go back to the tuning step.

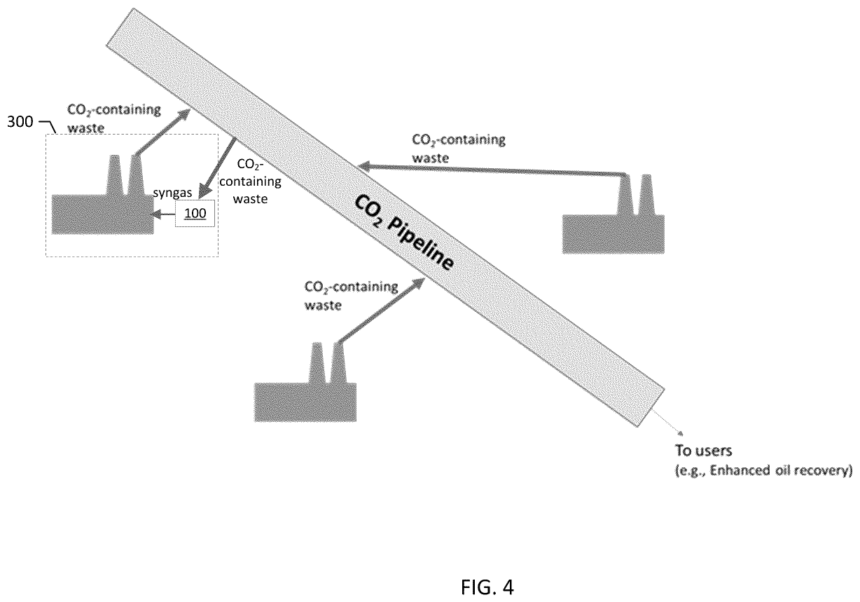

In some examples, the system 100 may be part of one of the one or more industrial facilities 300 as shown in FIG. 4. This may allow the one of the one or more industrial facilities 300 to provide and receive the carbon dioxide containing wastes at the same time. In some examples, a slipstream from the syngas produced from the system 100 can be utilized for power generation onsite or for heating purposes. In some examples, a slipstream from the syngas produced from the system 100 can be used for the production of hydrogen using appropriate separation processes.

In some examples, the system 100 of the present disclosure may source its reactants from natural gas, shale gas, flare gas, furnace gases, tail gases, landfill gases, bio-digesters, producer gas from biomass and coal gasification, and/or municipal waste gases. In some examples, the system 100 of the present disclosure may purify any material streams as necessary.

Aspects of the present disclosure may allow a tuned feed to be supplied to a syngas and carbon generator that can operate using multiple reforming and deposition techniques. Since some of these techniques may be endothermic and others may be exothermic, external heating and cooling utilities may be minimized through heat integration via a thermal storage and dispatch system, which may extract heat when the system is exothermic and provide heat when the system is endothermic. Thermal solar collectors may be also integrated with the thermal storage and dispatch system.

According to an embodiment of the present disclosure, elaborate mass and energy schemes, industrial symbiosis, and algorithmic calculations may be created to provide sustainable, flexible, tunable, and economically viable processes and products. This method may allow for removing carbon in a solid form, thereby effecting decarbonization from the atmospheric pollution of CO₂ and CH₄.

In particular, aspects of the present disclosure may uniquely address the integration of CO₂ pipelines with the critical infrastructure of natural/shale gas, CO₂ monetization technologies, processing facilities, solar-assisted reforming, and engineered production of solid carbon and syngas. The specific application involving the CO2 pipelines may enable a novel type of industrial symbiosis. Moreover, the use of C—H—O symbiosis via multi-scale atomic targeting may lead to unique and unexpected benefits, such as an ability to reach very high H₂:CO ratios, carbon sequestration, and synergistic interrelationships.

The use of the aforementioned approach may also help in targeting particular and very specific forms of carbon allotropes using the above-discussed algorithm/model. The method could take inputs from the reaction/kinetics of various carbon allotropes to decide the quality and quantity of the various exchange streams (including those imported from CO₂ network) that are fed to the process plants.

The use of the above-discussed algorithm/model in conjunction with the targeted quality of the carbon material formed may enable the selection of suitable technology (for instance CARGEN®), C2CNT, CARBONOVA among others within the constraints of available feed quality and the type of carbon allotrope that is desired. Systematic guidance of the end-users may enable the effective screening and selection of the desired options while accounting for economic, technical, and environmental objectives.

### Embodiments

Various aspects of the subject matter described herein are set out in the following numbered embodiments:

Embodiment 1. A system comprises: an allocation control system configured to: receive oxygen gas, methane gas, carbon dioxide gas, and steam, wherein at least a portion of the carbon dioxide gas is supplied from a carbon dioxide gas pipeline delivering carbon dioxide containing wastes generated from one or more industrial facilities; determine a proper ratio of the oxygen gas, the methane gas, the carbon dioxide gas, and the steam; and mix the oxygen gas, the methane gas, the carbon dioxide gas, and the steam according to the determined ratio to generate a mixture stream; and a syngas and carbon generator configured to: receive the mixture stream from the allocation control system; and generate syngas and solid carbon using the received mixture stream, wherein the syngas comprises hydrogen gas and carbon monoxide gas; wherein the proper ratio of the oxygen gas, the methane gas, the carbon dioxide gas, and the steam is determined using an atomic tracking model based on a predetermined condition for the syngas and the solid carbon to be generated by the syngas and carbon generator.

Embodiment 2. The system of embodiment 1, wherein the atomic tracking model uses the following chemical equation: CH₄+a CO₂+b H₂O+c O₂→d CO+r*d H₂+e Cs, where a, b, c, d, and e are coefficients, and r is a ratio between the hydrogen gas (H₂) to the carbon monoxide gas (CO).

Embodiment 3. The system of embodiment 2, wherein the determining the proper ratio comprises determining the coefficients of a, b, and c based on a predetermined value of d, e, and/or r.

Embodiment 4. The system of any one of embodiments 1-3, wherein the syngas and carbon generator is configured to generate the syngas using at least one of a Steam Methane Reforming (SMR) technique, a Partial Oxidation (POx) technique, and a Dry Reforming of Methane (DRM) technique.

Embodiment 5. The system of any one of embodiments 1-4, wherein the syngas and carbon generator is configured to generate the solid carbon using a carbon generator (CARGEN) reactor.

Embodiment 6. The system of any one of embodiments 1-5, wherein the system further comprises a thermal storage and dispatch system configured to: extract heat when the syngas and carbon generator is in an exothermic state; and supply heat when the syngas and carbon generator is in an endothermic state.

Embodiment 7. The system of any one of embodiments 1-6, wherein the predetermined condition for the solid carbon comprises a specific composition of the solid carbon.

Embodiment 8. The system of embodiment 7, wherein the specific composition of the solid carbon comprises at least one of carbon black, graphite, carbon nanotube, and graphene.

Embodiment 9. The system of any one of embodiments 1-8, wherein the predetermined condition for the syngas comprises a ratio between the hydrogen gas (H₂) to the carbon monoxide gas (CO)

Embodiment 10. The system of any one of embodiments 1-9, wherein mixing the oxygen gas, the methane gas, the carbon dioxide gas, and the steam according to the determined ratio to generate a mixture stream comprises adjusting a flow rate of at least one of the oxygen gas, the methane gas, the carbon dioxide gas, and the steam.

Embodiment 11. The system of any one of embodiments 1-10, wherein the system is part of one of the one or more industrial facilities, thereby allowing the one of the one or more industrial facilities to provide and receive the carbon dioxide containing wastes at the same time.

Embodiment 12. The system of any one of embodiments 1-11, further comprising a solar water electrolysis system including a solar water-electrolysis device, wherein the solar water-electrolysis device is configured to produce hydrogen gas and the oxygen gas via electrolysis of water using solar energy.

Embodiment 13. The method comprises: receiving oxygen gas, methane gas, carbon dioxide gas, and steam, wherein at least a portion of the carbon dioxide gas is supplied from a carbon dioxide gas pipeline delivering carbon dioxide containing wastes generated from one or more industrial facilities; determining a proper ratio of the oxygen gas, the methane gas, the carbon dioxide gas, and the steam; mixing the oxygen gas, the methane gas, the carbon dioxide gas, and the steam according to the determined ratio to generate a mixture stream; generating syngas and solid carbon using the generated mixture stream, wherein the syngas comprises hydrogen gas and carbon monoxide gas; wherein the proper ratio of the oxygen gas, the methane gas, the carbon dioxide gas, and the steam is determined using an atomic tracking model based on a predetermined condition for the syngas and the solid carbon to be generated.

Embodiment 14. The method of embodiment 13, wherein the atomic tracking model uses the following chemical equation: CH₄+a CO₂+b H₂O+c O₂→d CO+r*d H₂+e Cs, where a, b, c, d, and e are coefficients, and r is a ratio between the hydrogen gas (H₂) to the carbon monoxide gas (CO).

Embodiment 15. The method of embodiment 14, wherein the determining the proper ratio comprises determining the coefficients of a, b, and c based on a predetermined value of d, e, and/or r.

Embodiment 16. The method of any one of embodiments 13-15, wherein the predetermined condition for the solid carbon comprises a specific composition of the solid carbon.

Embodiment 17. The method of embodiment 16, wherein the specific composition of the solid carbon comprises at least one of carbon black, graphite, carbon nanotube, and graphene.

Embodiment 18. The method of any one of embodiments 13-17, wherein the predetermined condition for the syngas comprises a ratio between the hydrogen gas (H₂) to the carbon monoxide gas (CO)

Embodiment 19. The method of any one of embodiments 13-18, wherein mixing the oxygen gas, the methane gas, the carbon dioxide gas, and the steam according to the determined ratio to generate a mixture stream comprises adjusting a flow rate of at least one of the oxygen gas, the methane gas, the carbon dioxide gas, and the steam.

Embodiment 20. The method of any one of embodiments 13-19, wherein the generating the syngas comprises using at least one of a Steam Methane Reforming (SMR) technique, a Partial Oxidation (POx) technique, and a Dry Reforming of Methane (DRM) technique.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Reference throughout the specification to “various aspects,” “some aspects,” “some examples,” “other examples,” “some cases,” or “one aspect” means that a particular feature, structure, or characteristic described in connection with the aspect is included in at least one example. Thus, appearances of the phrases “in various aspects,” “in some aspects,” “certain embodiments,” “some examples,” “other examples,” “certain other embodiments,” “some cases,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a,” “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “at least one of X or Y” or “at least one of X and Y” should be interpreted as X, or Y, or X and Y.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

1. A system comprising:
an allocation control system configured to:
receive oxygen gas, methane gas, carbon dioxide gas, and steam, wherein at least a portion of the carbon dioxide gas is supplied from a carbon dioxide gas pipeline delivering carbon dioxide containing wastes generated from one or more industrial facilities;
determine a proper ratio of the oxygen gas, the methane gas, the carbon dioxide gas, and the steam; and
mix the oxygen gas, the methane gas, the carbon dioxide gas, and the steam according to the determined ratio to generate a mixture stream; and
a syngas and carbon generator configured to:
receive the mixture stream from the allocation control system; and
generate syngas and solid carbon using the received mixture stream, wherein the syngas comprises hydrogen gas and carbon monoxide gas;
wherein the proper ratio of the oxygen gas, the methane gas, the carbon dioxide gas, and the steam is determined using an atomic tracking model based on a predetermined condition for the syngas and the solid carbon to be generated by the syngas and carbon generator.

2. The system of claim 1, wherein the atomic tracking model uses the following chemical equation:
CH₄+aCO₂+bH₂O+cO₂→dCO+r*dH₂+eCs,
where a, b, c, d, and e are coefficients, and r is a ratio between the hydrogen gas (H₂) to the carbon monoxide gas (CO).

3. The system of claim 2, wherein the determining the proper ratio comprises determining the coefficients of a, b, and c based on a predetermined value of d, e, and/or r.

4. The system of claim 1, wherein the syngas and carbon generator is configured to generate the syngas using at least one of a Steam Methane Reforming (SMR) technique, a Partial Oxidation (POx) technique, and a Dry Reforming of Methane (DRM) technique.

5. The system of claim 1, wherein the syngas and carbon generator is configured to generate the solid carbon using a carbon generator (CARGEN) reactor.

6. The system of claim 1, further comprising a thermal storage and dispatch system configured to:
extract heat when the syngas and carbon generator is in an exothermic state; and
supply heat when the syngas and carbon generator is in an endothermic state.

7. The system of claim 1, wherein the predetermined condition for the solid carbon comprises a specific composition of the solid carbon.

8. The system of claim 7, wherein the specific composition of the solid carbon comprises at least one of carbon black, graphite, carbon nanotube, and graphene.

9. The system of claim 1, wherein the predetermined condition for the syngas comprises a ratio between the hydrogen gas (H₂) to the carbon monoxide gas (CO)

10. The system of claim 1, wherein mixing the oxygen gas, the methane gas, the carbon dioxide gas, and the steam according to the determined ratio to generate a mixture stream comprises adjusting a flow rate of at least one of the oxygen gas, the methane gas, the carbon dioxide gas, and the steam.

11. The system of claim 1, wherein the system is part of one of the one or more industrial facilities, thereby allowing the one of the one or more industrial facilities to provide and receive the carbon dioxide containing wastes at the same time.

12. The system of claim 1, further comprising a solar water electrolysis system including a solar water-electrolysis device, wherein the solar water-electrolysis device is configured to produce hydrogen gas and the oxygen gas via electrolysis of water using solar energy.

13. A method comprising:
receiving oxygen gas, methane gas, carbon dioxide gas, and steam, wherein at least a portion of the carbon dioxide gas is supplied from a carbon dioxide gas pipeline delivering carbon dioxide containing wastes generated from one or more industrial facilities;
determining a proper ratio of the oxygen gas, the methane gas, the carbon dioxide gas, and the steam;
mixing the oxygen gas, the methane gas, the carbon dioxide gas, and the steam according to the determined ratio to generate a mixture stream;
generating syngas and solid carbon using the generated mixture stream, wherein the syngas comprises hydrogen gas and carbon monoxide gas;
wherein the proper ratio of the oxygen gas, the methane gas, the carbon dioxide gas, and the steam is determined using an atomic tracking model based on a predetermined condition for the syngas and the solid carbon to be generated.

14. The method of claim 13, wherein the atomic tracking model uses the following chemical equation:
CH₄+aCO₂+bH₂O+cO₂→dCO+r*dH₂+eCs,
where a, b, c, d, and e are coefficients, and r is a ratio between the hydrogen gas (H₂) to the carbon monoxide gas (CO).

15. The method of claim 14, wherein the determining the proper ratio comprises determining the coefficients of a, b, and c based on a predetermined value of d, e, and/or r.

16. The method of claim 1, wherein the predetermined condition for the solid carbon comprises a specific composition of the solid carbon.

17. The method of claim 16, wherein the specific composition of the solid carbon comprises at least one of carbon black, graphite, carbon nanotube, and graphene.

18. The method of claim 13, wherein the predetermined condition for the syngas comprises a ratio between the hydrogen gas (H₂) to the carbon monoxide gas (CO)

19. The method of claim 13, wherein mixing the oxygen gas, the methane gas, the carbon dioxide gas, and the steam according to the determined ratio to generate a mixture stream comprises adjusting a flow rate of at least one of the oxygen gas, the methane gas, the carbon dioxide gas, and the steam.

20. The method of claim 13, wherein the generating the syngas comprises using at least one of a Steam Methane Reforming (SMR) technique, a Partial Oxidation (POx) technique, and a Dry Reforming of Methane (DRM) technique.
